(19) United States
(12) Patent Application Publication
(10) Pub. No.: US 2002/0021717 A1
(43) Pub. Date: Feb. 21, 2002

(54) Method and system for transmit time stamp insertion in a hardware time stamp system for packetized data networks

(76) Inventors: Kaynam Hedayat, Chestnut Hill, MA (US); Laco Scott Harvell, Brookline, NH (US); Sadredin Tavana, Sudbury, MA (US); Steven A. DesRochers, Londonderry, NH (US)

Correspondence Address: Mark G. Lappin, P.C., McDERMOTT, WILL & EMERY, 28 State Street, Boston, MA, 02109, US

(21) Appl. No.: 09/860,297

(22) Filed: May 18, 2001

Related U.S. Application Data
(60) Provisional application No. 60/264,356, filed on Jan. 26, 2001.
(60) Provisional application No. 60/205,280, filed on May 18, 2000.

(51) Int. Cl. H04J 3/06

(52) U.S. Cl. 370/508; 370/512

(57) ABSTRACT

A system for time-stamping a data packet associated with a data network includes a network media interface device for transferring a data packet to a network medium, and a time source for generating and maintaining a time code. The system further includes a time-stamping circuit for sampling the time code from the time source when the data packet is available to be transferred to the network medium so as to acquire an outgoing time code. The time-stamping circuit also embeds the outgoing time code into a predetermined field in the data packet. The time-stamping circuit also provides the data packet with the embedded outgoing time code to the interface device, and the interface device subsequently transfers the data packet to the network medium.

### BACKGROUND OF THE INVENTION

The present invention relates to packetized data networks, and more particularly, to determining time-of-transmission and time-of-arrival of data packets on a data network.

In order to evaluate the functionality and efficiency of a packetized data network, network software applications often monitor many aspects of packet traffic on the network. For example, in order to determine packet propagation delay (also referred to herein as “transit delay,” “transit time” or “propagation time”) from one point on the network to another, a network software application can time-tag (also referred to herein as “time-stamp”) individual packets as they are transmitted or received and use the time-stamp information to determine propagation time. As used herein, the term “time-tag” or “time-stamp” means to sample a chronometer (or other reference time code source) when the packet is at a particular location in the network, then associate the sampled time code with the packet. Some prior art systems time-stamp the packets that are used in a “ping test” to determine packet propagation delay on a network. A ping test uses echo request packets and echo response packets to create a loop-back test between two stations on a network. FIG. 1 illustrates how a prior art system 10 uses a ping test to determine packet propagation delay. The system 10 includes a first station 12 and a second station 14 that communicate via a network medium 16. Each station includes test application software 18, several layers of intermediate software 20, a medium access controller (MAC) 22, and a physical medium interface (PHY) 24 (e.g., an Ethernet interface). The test application software 18:1 in the first station 12 generates and time-stamps an echo request packet. The application software 18:1 immediately sends the packet through the layers of intermediate software 20:1 (also referred to herein as the “software stack”), the MAC 22:1 and the PHY 24:1, and out to the second station 14 via the network medium 16. When the echo request packet reaches the second station 14, the packet passes through the PHY 24:2, the MAC 22:2, the software stack 20:2, and is received by the application software 18:2. The application software 18:2 compiles an echo response packet and sends the response packet back through the stack 20:2, the MAC 22:2, the PHY 24:2 and out to the first station 12 via the network medium 16. When the echo response packet reaches the first station 12, the packet passes through the PHY 14:1, the MAC 22:1, the stack 20:1 and is received and time-tagged by the application software 18:1. The application software 18:1 calculates the difference between the time-tag of the received echo request packet and the time-tag of the transmitted echo response packet to determine the round-trip propagation delay of the packet.

One disadvantage of such prior art systems is that since the packet time-tagging occurs at the application software 18:1, the propagation times through the software stacks 20:1 and 20:2 are included in the round trip time that the application software 18:1 calculates. The propagation times through the software stacks 20:1 and 20:2 are subject to non-deterministic delays induced by operating systems and software processes. The delays are non-deterministic because the operating systems and software processes are typically multitasking, and thus dependent on instantaneous loading from various external factors. Further, the chronometer that a typical prior art system uses is often software-based, and therefore vulnerable to the same non-deterministic effects that influence the software stacks. Since the delays induced via such prior art time stamping schemes are non-deterministic, accurate arrival and network infrastructure transit times are not possible to predict. An accurate arrival time for packets is of particular interest in communications systems for applications that are delay-bounded, such as voice and video. This is especially true when the inaccuracy in marking transmit and arrival times is greater than the jitter and delay resolution required by real time application.

It is an object of the present invention to substantially overcome the above-identified disadvantages and drawbacks of the prior art.

### SUMMARY OF THE INVENTION

The present invention allows software applications, running on a non-deterministic system, to determine precise timing information about when packet data was transmitted into a physical network. The invention allows the user to be unconcerned with the communications stack/stacks that are used (i.e., the network applications at the various layers of the network), as the entire contribution of the software system is effectively removed from the ending calculations. The invention thus determines only the network transaction time (i.e., within the physical network) involved in a data transaction between two computers separated by a data network of arbitrary size.

The foregoing and other objects are achieved by the invention which in one aspect comprises a system for time-stamping a data packet associated with a data network. The system includes a network media interface device for transferring a data packet to a network medium, and a time source for generating and maintaining a time code. The system further includes a time-stamping circuit for sampling the time code from the time source when the data packet is available to be transferred to the network medium so as to acquire an outgoing time code. The time-stamping circuit also embeds the outgoing time code into a predetermined field in the data packet. The time-stamping circuit also provides the data packet with the embedded outgoing time code to the interface device, and the interface device subsequently transfers the data packet to the network medium.

In another embodiment of the invention, the network media interface device includes an Ethernet interface device for implementing an Ethernet protocol on the network media.

Another embodiment of the invention further includes a registration module for designating one or more specific packets. The time-stamping circuit receives the specific packet designations from the registration module, and embeds the time code into only those specific packets corresponding to the specific packet designations of all the transferred to the network medium.

In another embodiment of the invention, the time-stamping circuit further samples a time code from the time source to acquire an incoming time code when the interface device receives an incoming data packet from the network medium. The time-stamping circuit associates the incoming time code with the incoming data packet so as to form an incoming time-stamped packet.

In another embodiment of the invention, the time-stamping circuit further includes a memory circuit for storing the incoming time-stamped packet.

Another embodiment of the invention further includes an application software package for receiving the incoming time-stamped packet from the time stamping-circuit, and for calculating a time difference therefrom.

In another embodiment of the invention, the application software package calculates the time difference by subtracting the outgoing time code embedded in the incoming packet from the incoming time code associated with the incoming packet.

In another embodiment of the invention, the time-stamping circuit passes the incoming time-stamped packet to the application software package via a media access controller.

In another embodiment of the invention, the incoming time-stamped packet includes at least a portion of the time code in a CRC field of the packet.

In another embodiment of the invention, the time stamping circuit passes the incoming data packet to the application software package via a media access controller, and passes the associated incoming time code to the application software package via an asynchronous interface controller.

In another aspect, the invention comprises a method of time-stamping a data packet associated with a data network. The method includes generating and maintaining a time code, and sampling the time code from the time source when the data packet is available to be transferred to the network medium so as to acquire an outgoing time code. The method further includes embedding the outgoing time code into a predetermined field in the data packet, and providing the data packet with the embedded outgoing time code to a network interface device. The interface device subsequently transfers the data packet to the network medium.

Another embodiment of the invention further includes designating one or more specific packets. The time-stamping circuit receives the specific packet designations from a registration module, and embeds the time code into only those specific packets corresponding to the specific packet designations of all the transferred to the network medium.

Another embodiment of the invention further includes sampling a time code from the time source to acquire an incoming time code when the interface device receives an incoming data packet from the network medium. The method further includes associating the incoming time code with the incoming data packet so as to form an incoming time-stamped packet.

Another embodiment of the invention further includes providing a memory circuit for storing the incoming time-stamped packet.

Another embodiment of the invention further includes receiving the incoming time-stamped packet from the time stamping-circuit, and calculating a time difference therefrom.

Another embodiment of the invention further includes calculating the time difference by subtracting the outgoing time code embedded in the incoming packet from the incoming time code associated with the incoming packet.

Another embodiment of the invention further includes receiving the incoming time-stamped packet via a media access controller.

### BRIEF DESCRIPTION OF DRAWINGS

The foregoing and other objects of this invention, the various features thereof, as well as the invention itself, may be more fully understood from the following description, when read together with the accompanying drawings in which:

FIG. 1 illustrates a prior art system using a ping test to determine packet propagation delay;

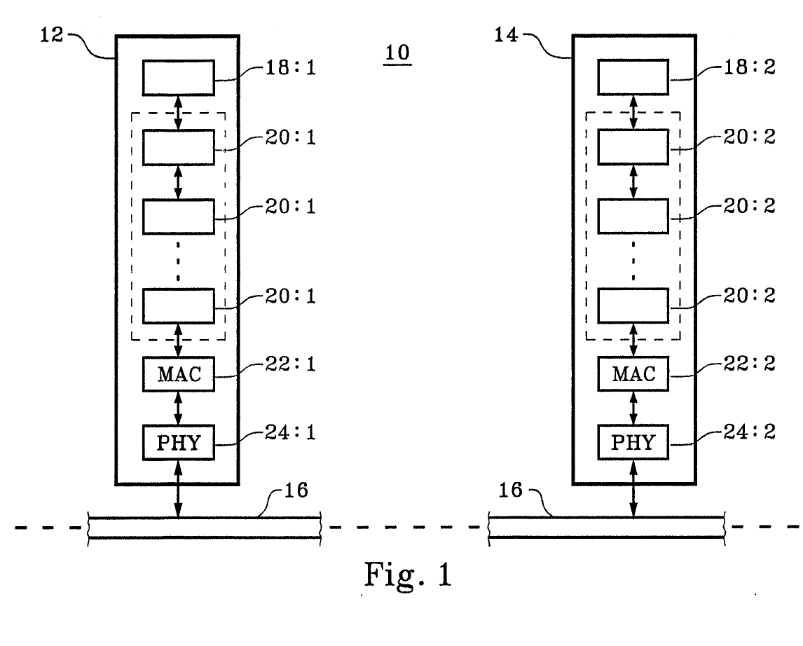

FIG. 2 shows one embodiment of a system for time stamping a data packet associated with a data network according to the present invention;

FIG. 3 illustrates another embodiment of the system of FIG. 2; and,

FIG. 4 shows an architecture for determining the propagation delay from one network station to another, using the system of FIG. 2.

### DESCRIPTION OF THE PREFERRED EMBODIMENTS

The present invention, a system for transmit hardware time stamping and registration of packetized data, substantially eliminates the aforementioned uncertainties introduced by software time stamping schemes. The invention allows highly accurate measurements of network transit times for packetized data. The invention associates a distinct time code (also referred to herein as “time-stamp”) that designates a chronological reference point with each packet received from or provided to the physical media. The time code association is performed by hardware to minimize non-deterministic delays and other uncertainties associated with handling packets in software. In general, the time code that is associated with a packet is correlated to when a specific, predetermined point on the packet is at a particular place in the system. For example, in one embodiment, the time code may be correlated to when the beginning of the first bit of the packet is received from the physical media. In another embodiment, the time code may be correlated to when the end of the last bit of the packet is received from the physical media.

The time source (i.e., the source of the time code) may be any type of chronometer known in the art. In one embodiment, the time source is a simple free running counter running from a relatively stable local oscillator. In another embodiment, the time source may include a GPS based time source that is disciplined to UTC (Universal Time). An advantage of a GPS based time source is that several remote network stations can all be synchronized to within the dissemination error of the GPS system.

Each packet that is received from or provided to the physical network will have a unique time-stamp associated with it. A software process that has non-deterministic delays can process these hardware time-stamped packets in the future, on a non-real time basis, without losing precise arrival-time or transmit-time information, since each packet is associated with its own distinct time-stamp value.

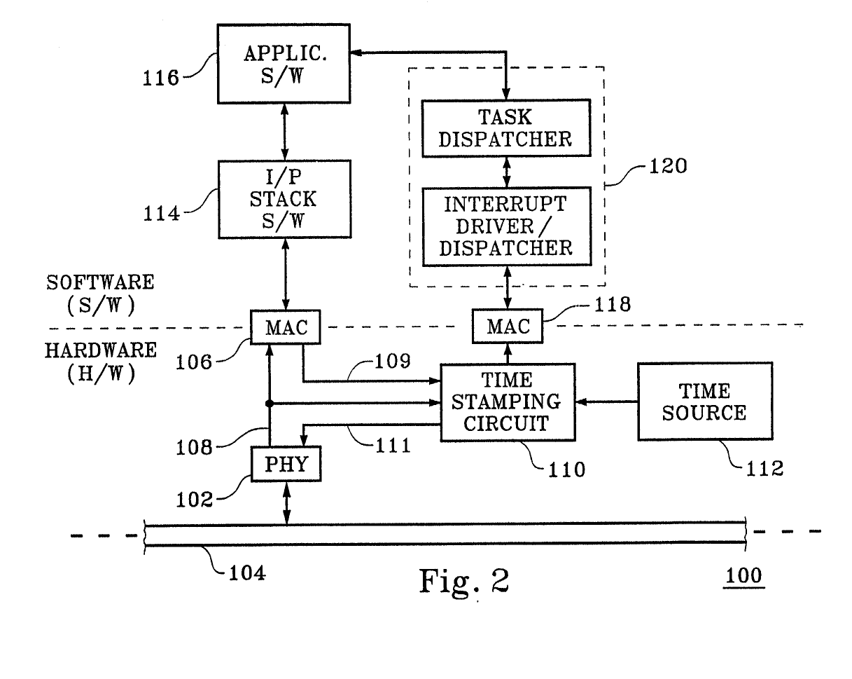

One embodiment of a system for time stamping a data packet associated with a data network 100 is shown in block diagram form in FIG. 2. The system 100 includes a network media interface device 102 (also referred to herein as “physical interface” or “PHY”) coupled to a network medium 104 so as to facilitate packet transfer between the PHY 102 and the network medium 104. The PHY 102 is also coupled to a media interface controller 106 (also referred to herein as “MAC”) via an incoming data interface 108. The MAC 106 receives, via the incoming data interface 108, incoming packets from the PHY 102 that are to be sent out on the medium 104. A time-stamping circuit 110 also receives incoming packets via the incoming data interface 108. Each time the time-stamping circuit 110 receives a packet from the interface 108, the time-stamping circuit 110 samples the time source 112 to acquire a time code, and associates that time code with the incoming packet. The incoming packet, together with the associated time code, are referred to herein collectively as a “time-stamped incoming packet.” The MAC 106 also provides outgoing packets, via a first outgoing interface 109, to the time stamping circuit 110. The time-stamping circuit 110 embeds a time code in the outgoing packet (described in more detail herein), and provides the outgoing data packet with the embedded time code to the interface device 102 via a second outgoing interface 111. The PHY 102 transmits the outgoing packet on the physical media 104. The outgoing data packet with the embedded time code referred to herein as a “time-stamped outgoing packet.”

It is important to note that the mechanism for time-stamping outgoing data packets is not the same as the mechanism for time-stamping incoming data packets. The system 100 time-stamps outgoing packets by embedding a time code in a field within the packet itself prior to transmitting the packet on the network media 104. By contrast, the system time-stamps incoming packets by merely associating a time code with the packet. Some embodiments of the invention may subsequently embed at least a portion of the time code in the incoming packet by “stealing” an existing field of the packet prior to relaying the packet for processing elsewhere within the system. Other embodiments of the invention may relay the time code and the packet via separate channels, while maintaining the association. Details of these different embodiments are described herein.

In either case, the temporal relationship between when the time-stamping circuit 110 in FIG. 2 receives a particular packet from the interface 108 and when the time-stamping circuit 110 samples the time source 112 is critical. In some embodiments of the invention, the time code that the time-stamping circuit 110 associates with a particular packet represents the exact state of the time source 112 when the time-stamping circuit 110 receives the packet. In other embodiments, the time code that the time-stamping circuit 110 associates with a particular packet may be a fixed offset from the exact state of the time source 112 when the time-stamping circuit receives the packet. In any case, the time code associated with the packet in the time-stamping circuit 110 has a fixed temporal relationship with the state of the time source 112 when the time-stamping circuit receives the packet.

In one embodiment, the system 100 further includes an I/P stack 114, which is characterized by one or more software processes that handle various processing layers inherent in the packet data structure. The system 100 also includes an application software package 116 that handles the end-product of the packet communication. For example, the application software 116 may include a test application that generates the aforementioned “ping” messages, and calculates transit delays from the time codes associated therewith. For an outgoing message, the application software 116 generates the outgoing message and passes it to the I/P stack 114. The I/P stack 114 receives the outgoing message, uses it to compile an outgoing packet, and passes the outgoing packet to the MAC 106. For an incoming message, the I/P stack 114 receives an incoming packet from the MAC 106, de-compiles it to access the layer that carries the incoming message, and passes the incoming message to the application software 116.

For outgoing packets: when the I/P stack 114 of FIG. 2 provides outgoing packet data to the MAC 106 for transmission to the media 104, the I/P stack 114 also provides registration data associated with the packet data. The registration data specifies, among other parameters, the offset from the beginning of the packet at which to insert the timestamp. When the MAC 106 transfers the packet data of a specified type to the time-stamping circuit 110, the MAC 106 includes a header that indicates the offset from the beginning of the packet at which the timestamp should be inserted. The time-stamping circuit 110 reads the header, then uses the offset information therein to determine where to insert the timestamp information while compiling the outgoing packet. The time-stamping circuit 110 discards the header, inserts the timestamp in the appropriate location, then calculates and appends a new CRC to the packet data. Due to bandwidth timing requirements, the header that is prepended to the packet (which is subsequently stripped), and the timestamp that is inserted are preferably the same size. This means that the physical hardware interface does not need to generate more bandwidth than the resulting data stream.

The utility of this embodiment is to reduce the communication needed between tests running on different stations along the network 104. Without this utility, the timestamp must be communicated between the different systems after the test data has been transferred, in order to perform propagation time calculations. By putting the timestamp in the packet data, no further timing data needs to be transacted.

For incoming packets: the time-stamping circuit 110 passes incoming packets to the application software 116 via a time-stamp MAC 118 and a dispatcher software process 120. Some incoming packets may include an embedded time code as described herein, but other packets without embedded time code information may also be received and time-stamped. In an embodiment of the invention that is particularly suitable for Ethernet based networks, the time-stamping circuit 110 combines the associated time-code and a CRC (cyclic redundancy code) word from the incoming packet, and places the combination in the original CRC field to form a time-stamped packet. Ethernet packets propagate on the network medium 104 with a potentially small Inter Packet Gap (hereinafter referred to as “IPG”) between each packet, depending on the packet rate. Such a small IPG makes appending a time code to these packets “on the fly” (i.e., in real time) difficult for two reasons. First, since a minimum IPG is required for proper operation of an Ethernet MAC, “stealing” any portion of the IPG for a time-stamp necessarily reduces the maximum data rate of the Ethernet channel. The Ethernet MAC is shown as the time-stamp MAC 118 in FIG. 2, although in general, the time-stamp MAC 118 may handle alternative communications protocols in other embodiments. Second, appending a time stamp to the end of an Ethernet packet will cause the Ethernet MAC to reject the packet, since the time-stamped packet will not appear to contain the proper CRC. Ethernet packets include a 32-bit CRC field, which are always placed in the last 4 bytes of the packet. If a time code is appended to the end of an Ethernet packet, the MAC will treat the last 4 bytes of this time code as the CRC field, which will in most instances produce an error indication from the CRC calculation.

In one embodiment of the invention, the time-stamping circuit 110 uses the CRC field of an incoming packet to transport the time-code. For each received packet, the time-stamping circuit 110 validates the CRC of the packet and indicates any errors via a single status bit. Methods of validating the packet CRC are well known in the art, and are not described herein. The time-stamping circuit combines the status bit and the time code and inserts them into the original CRC field of the packet. In one embodiment, the status bit is pre-pended to the time stamp value, although the status bit may be included in any predetermined position within the CRC field. The system 100 configures the Ethernet MAC to receive the incoming packet from the time-stamping circuit 110 without performing a CRC validation check. This will allow the Ethernet MAC 118 to store the packets with the time-code intact in its packet buffer memory. A software process referred herein to as the “dispatcher” 120 receives the time-stamped packet from the Ethernet MAC 118. The MAC 118 checks the CRC status bit and invalidates the packet if the status bit indicates an error.

The dispatcher 120 includes an interrupt-driven dispatcher 122, and a task dispatcher 124. Each time the time-stamp MAC 118 has a time-stamped packet available for the interrupt-driven dispatcher 122, the time-stamp MAC 118 issues an interrupt to the associated processor, and the processor vectors to the interrupt-driven dispatcher 122. The interrupt-driven dispatcher fetches the time-stamped packet from the MAC 118, and routes the packet to the task dispatcher 124.

The task dispatcher 124 receives registration information from a registration software module in the application software 116 that identifies and designates particular packets. The task dispatcher 122 compares the time-stamped packet to the registration information; if the time-stamped packet matches any of the packets listed in the registration information, the task dispatcher passes that time-stamped packet on to the application software 116. The comparison that the task dispatcher 122 performs may include a bit-wise comparison of selected fields in the packet. Alternately, the comparison may include a bit-wise comparison of only particular bits in the packet, or it may include a bit-wise comparison of all bits in the packet.

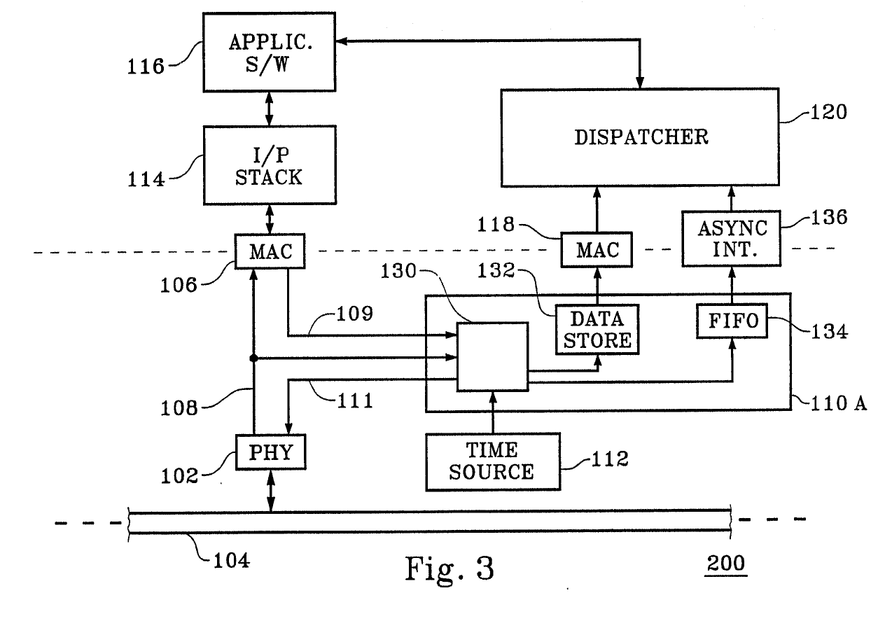

In another embodiment, the time-stamping circuit 110 may provide the incoming time-stamped packet to the application software 116 by separately transferring the time-code and the associated packet across distinct channels, as shown in FIG. 3. The distinction between the embodiment of FIG. 2 and FIG. 3 is for the incoming packets only. The mechanism for time-stamping outgoing packets in the embodiment of FIG. 3 is the same for the embodiment of FIG. 2. The time-stamp circuit 110A in this embodiment includes the primary time-stamping circuitry 130, a data store 132 and a FIFO 134. For each packet the time-stamp circuit 110A receives from the incoming data interface 108, the circuitry 130 samples the time-source 112 for a time-code and associates the time code with the packet, as described herein. The circuitry 130 then provides the packet to the data store 132 and provides the associated time code to the FIFO 134. The dispatcher 120 then accesses the data store 132 and the FIFO 134 in lock-step (i.e., synchronized), so that the associated packets and time-codes are taken together. The dispatcher 120 receives the packets from the time-stamp MAC 118 via an interrupt-driven dispatcher, as described herein. The dispatcher 120 receives the associated time-code via an asynchronous interface device 136. Although the dispatcher 120 does not need to remove the associated time code at the same time that it removes the packet, dispatcher 120 must remove the associated time-code from the FIFO prior to removing another packet in order to remain in lock-step.

In a preferred embodiment, the time code that the time source 112 maintains includes a 64 bit word, with the least significant bit corresponding to 1 nS. Time-codes having other lengths may be used in alternative embodiments to provide different time resolutions; the 64 bit code described herein is merely an illustrative example. One disadvantage to the embodiment shown in FIG. 2 is that only the 31 least significant bits (low order bits) of the time code can be combined with the status bit and sent across the MAC 118 in the CRC field of the packet. This embodiment copes with such a truncation by maintaining an mirror version of the most significant 33 bits (high order bits) of the time code in the dispatcher 120, and monitoring the low order bits in the consecutive time-stamped packets for roll-over as they reach the dispatcher 120. When the low order bits in consecutive packets transition from a large value to a small value, roll-over is indicated. Further, the dispatcher 120 may periodically poll the time source 112 to maintain synchronization between the two sets of high order bits. The embodiment shown in FIG. 3 circumvents the time-code truncation issue by utilizing a 64 bit FIFO 134, and passing the entire 64 bit word to the dispatcher 120 via the asynchronous interface 136.

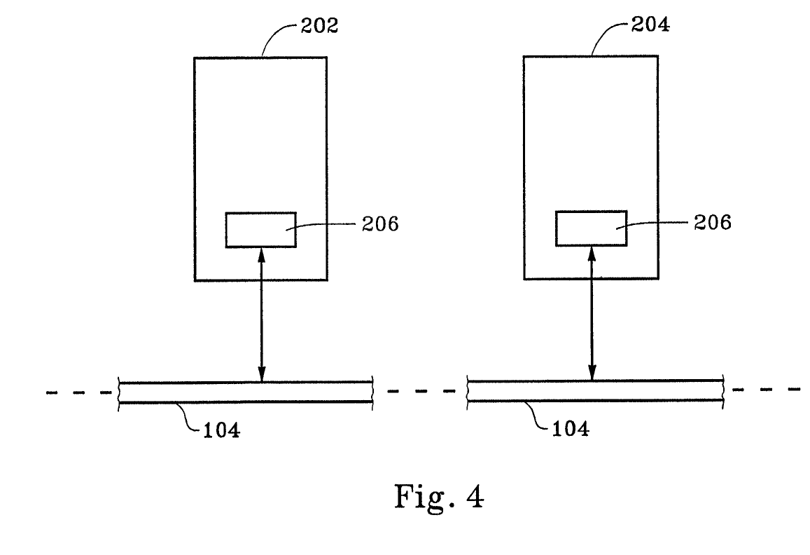

A system for time stamping a data packet associated with a data network 100 as described herein is useful for determining the propagation delay from one network station to another. The network architecture shown in FIG. 4 includes a first station 202 and a second station 204 both connected to a network medium 104. Each station includes a system for time stamping a data packet associated with a data network 206. The system 206 may include the embodiment described in either FIG. 2 or FIG. 3. In one embodiment, the sequence of events for calculating packet transit delay is as follows:

(1) The first station 202 initiates the calculation by sending a test packet characterized by a first predetermined identification (ID) code to the second station.

(2) The first station 202 time-stamps the test packet as it is transmitted to the medium 104 by embedding a time code in the test packet.

(3) The second station 204 time-stamps the test packet when the second station 204 receives the test packet from the medium 104.

After receiving the test packet, the second station 204 has the time-code that was associated with the test packet at the first station (via the embedded time code), and the time-code that was associated with the test packet at the second station 204 (via the “incoming packet” time-stamping at the second station). Both time-codes were generated via hardware time-stamping circuit as described herein, thus eliminating software-induced uncertainty. In this embodiment, the time source associated with the first station 202 and the time source associated with the second station 204 are synchronized in some manner, e.g., via GPS or other synchronization method known in the art. Finally,

(4) The second test station 204 calculates the difference between the time-code that was associated with the test packet at the first station, and the time-code that was associated with the test packet at the second station 204, to determine the packet transit delay.

An advantage of determining the packet transit delay by time-stamping a packet at two network stations is that one-way packet transit time may be accurately calculated. In prior art systems that determine the “round trip” transit time of the packet, the one way transit time may be estimated by assuming a symmetrical network and dividing the round-trip time in half. However, many networks are not symmetrical, so simply dividing the round-trip time in half may be inaccurate. Further, the fact that the first station 202 embeds the transmit time code in the outgoing test packet means that a single test message from the first station 202 to the second station provides sufficient information at the second station 202 to calculate the propagation delay from the first station 202 to the second station 204.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. A system for time-stamping a data packet associated with a data network, comprising:
a network media interface device for transferring a data packet to a network medium;
a time source for generating and maintaining a time code;
a time-stamping circuit for (i) sampling the time code from the time source when the data packet is available to be transferred to the network medium so as to acquire an outgoing time code, (ii) embedding the outgoing time code into a predetermined field in the data packet, and (iii) providing the data packet with the embedded outgoing time code to the interface device;
wherein the interface device subsequently transfers the data packet to the network medium.

2. A system according to claim 1, wherein the network media interface device includes an Ethernet interface device for implementing an Ethernet protocol on the network media.

3. A system according to claim 1, further including a registration module for designating one or more specific packets, wherein the time-stamping circuit receives the specific packet designations from the registration module, and embeds the time code into only those specific packets corresponding to the specific packet designations of all the transferred to the network medium.

4. A system according to claim 1, wherein the time-stamping circuit further samples a time code from the time source to acquire an incoming time code when the interface device receives an incoming data packet from the network medium, and associates the incoming time code with the incoming data packet so as to form an incoming time-stamped packet.

5. A system according to claim 4, wherein the time-stamping circuit further includes a memory circuit for storing the incoming time-stamped packet.

6. A system according to claim 1, further including an application software package for receiving the incoming time-stamped packet from the time stamping-circuit, and for calculating a time difference therefrom.

7. A system according to claim 6, wherein the application software package calculates the time difference by subtracting the outgoing time code embedded in the incoming packet from the incoming time code associated with the incoming packet.

8. A system according to claim 6, wherein the time-stamping circuit passes the incoming time-stamped packet to the application software package via a media access controller.

9. A system according to claim 8, wherein the incoming time-stamped packet includes at least a portion of the time code in a CRC field of the packet.

10. A system according to claim 4, wherein the time stamping circuit passes the incoming data packet to the application software package via a media access controller, and passes the associated incoming time code to the application software package via an asynchronous interface controller.

11. A method of time-stamping a data packet associated with a data network, comprising:
generating and maintaining a time code;
sampling the time code from the time source when the data packet is available to be transferred to the network medium so as to acquire an outgoing time code;
embedding the outgoing time code into a predetermined field in the data packet, and,
providing the data packet with the embedded outgoing time code to a network interface device, wherein the interface device subsequently transfers the data packet to the network medium.

12. A method according to claim 11, wherein the network media interface device includes an Ethernet interface device for implementing an Ethernet protocol on the network media.

13. A method according to claim 11, further including designating one or more specific packets, wherein the time stamping circuit receives the specific packet designations from a registration module, and embedding the time code into only those specific packets corresponding to the specific packet designations of all the transferred to the network medium.

14. A method according to claim 11, further including sampling a time code from the time source to acquire an incoming time code when the interface device receives an incoming data packet from the network medium, and associating the incoming time code with the incoming data packet so as to form an incoming time-stamped packet.

15. A method according to claim 14, further including providing a memory circuit for storing the incoming time-stamped packet.

16. A method according to claim 11, further including receiving the incoming time-stamped packet from the time stamping-circuit, and for calculating a time difference therefrom.

17. A method according to claim 16, further including calculating the time difference by subtracting the outgoing time code embedded in the incoming packet from the incoming time code associated with the incoming packet.

18. A method according to claim 14, further including receiving the incoming time-stamped packet via a media access controller.
